(19) United States
(12) Patent Application Publication
(10) Pub. No.: US 2007/0216805 A1
(43) Pub. Date: Sep. 20, 2007

(54) MULTI-IMAGE DISPLAY APPARATUS

(75) Inventors: Takeshi Yamamoto, Kyoto (JP); Akira Imai, Nara (JP); Toshiya Takahashi, Kyoto (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(73) Assignee: SHARP KABUSHIKI KAISHA, Osaka-shi, Osaka (JP)

(21) Appl. No.: 11/576,520

(22) PCT Filed: Sep. 30, 2005
(86) PCT No.: PCT/JP05/18163

§ 371 Date: Apr. 2, 2007

(30) Foreign Application Priority Data
Oct. 4, 2004 (JP) 2004-291884

(51) Int. Cl. H04N 5/45

(52) U.S. Cl. 348/565

(57) ABSTRACT

A multi-image display apparatus of the present invention displays a sub-screen which displays information indicative of a current display mode in each of (i) a screen image (left screen image) when viewed from the left side of a display section and (ii) a screen image (right screen image) when viewed from the right side of the display section. For example, in a case where a screen image A is displayed in the left screen image and a screen image B is displayed in the right screen image, the sub-screen displays an icon indicating a dual view mode. On the other hand, in a case where the screen image A is displayed in each of the left screen image and the right screen image, the sub-screen displays an icon indicating a single view mode.

### BACKGROUND OF THE INVENTION

1. Field of the Invention

The present invention relates to a multi-image display apparatus capable of displaying different images when viewed from a plurality of view points.

2. Description of the Related Art

Conventionally, a display apparatus displaying different images when viewed from a plurality of view points is proposed as, for example, a three dimensional image display apparatus in which a display panel is combined with viewing angle controlling means such as a parallax barrier. As illustrated in FIG. 10, such a three dimensional display apparatus includes: a display panel 101 and a parallax barrier 102 as viewing angle controlling means. The display panel 101 provides a left-eye image and a right-eye image thereon. The parallax barrier 102, which is provided outside the display panel 101, gives specific viewing angles with respect to the left-eye image and the right-eye image. As illustrated in FIG. 11, in a specific observing region in a space, a left eye and a right eye of an observer can see their respectively corresponding images, and the observer can recognize a three dimensional image.

The three-dimensional display as mentioned above is not only the possibility of application of a display apparatus in which a display panel is combined with viewing angle controlling means so that different images are displayed when viewed from a plurality of view points. For example, the display apparatus is applicable to display (hereinafter, referred to as dual image display) showing different images when viewed by a plurality of observers. In other words, as illustrated in FIG. 12(a), in the three dimensional display, the right-eye image and the left-eye image, which are separated by their respective viewing angles, are observed respectively by a right eye and a left eye of one observer. On the other hand, in the dual image display, as illustrated in FIG. 12(b), a first image and a second image, which are separated by their respective viewing angles, are respectively observed by different observers.

In such a dual image display apparatus, an image separation angle is arranged to be larger than that of the three dimensional display by changing a setup condition such as a pixel pitch and a distance between a panel and a barrier. However, the dual image display apparatus separates images with the use of viewing angles on the same principle as the three dimensional apparatus. Moreover, display of equal to or more than three images becomes possible on the same principle by increasing number of viewing points from which different images can be observed.

A system used in each of the three dimensional display apparatus and the dual image display apparatus is not limited to a system in which a parallax barrier is used as the viewing angle controlling means. Apart from this, there are proposed various systems in which a lenticular lens, a prism lens, or the like is used. For example, Japanese Unexamined Patent Publication No. 57392/1987 (Tokukaishou 62-57392) (published on Mar. 13, 1987) (Patent Document 1), Japanese Unexamined Patent Publication No. 182632/1988 (Tokukaishou 63-182632) (published on Jul. 27, 1988) (Patent Document 2), Japanese Unexamined Patent Publication No. 230699/1991 (Tokukaihei 3-230699) (published on Oct. 14, 1991) (Patent Document 3), Japanese Unexamined Patent Publication No. 195049/1994 (Tokukaihei 6-195049) (published on Jul. 15, 1994) (Patent Document 4), Japanese Patent Publication No. 3133478(published on Nov. 19, 1993) (Patent Document 5), Japanese Patent Publication No. 3398999 (published on Aug. 23, 1994) (Patent Document 6), Japanese Patent Publication No. 3184069(published on May 31, 1996) (Patent Document 7), and Japanese Unexamined Patent Publication No. 137443/2000 (Tokukai 2000-137443) (published on May 16, 2000) (Patent Document 8) disclose a technique concerning three dimensional display and dual image display.

However, in a multi-image display (hereinafter, “multi-image display” refers to display of equal to or more than two images), each observer cannot recognize an image that another observer sees. This causes a problem in that communication between the observers becomes difficult.

### SUMMARY OF THE INVENTION

An object of the present invention is to realize a multi-image display apparatus which is capable of providing each observer with information on an image that another observer sees in a multi-image display.

In order to achieve the object mentioned above, a multi image display apparatus according to the present invention is a multi-image display apparatus capable of displaying different images when viewed from a plurality of view points includes display information providing means which is capable of providing display information concerning an image viewed from another view point.

According to the above-mentioned arrangement, the information on an image that another observer sees can be provided to each observer with the use of the display information providing means. This allows to avoid an occurrence of a problem in that each observer cannot recognize an image that another observer sees and thus communication between the observers becomes difficult.

### BRIEF DESCRIPTION OF THE DRAWINGS

FIGS. 1(a) and 1(b) illustrate one example of display on a multi-image display apparatus according to Embodiment 1. FIG. 1(a) is a diagram illustrating a display state in a dual view mode. FIG. 1(b) is a diagram illustrating a display state in a single view mode.

FIG. 2 is a cross sectional view schematically illustrating an arrangement of a display panel of a liquid crystal multi-image display apparatus according to the present invention.

FIG. 3 is a block diagram schematically illustrating an arrangement of the liquid crystal multi-image display apparatus according the present invention.

FIGS. 4(a) and 4(b) illustrate another example of display on the multi-image display apparatus according to Embodiment 1. FIG. 4(a) is a diagram illustrating a display state in a dual view mode. FIG. 4(b) is a diagram illustrating a display state in a single view mode.

FIGS. 5(a), 5(b), and 5(c) illustrate yet another example of display on the multi-image display apparatus according to Embodiment 1. FIG. 5(a) is a diagram illustrating a display state in a dual view mode. FIG. 5(b) is a diagram illustrating a display state in a single view mode. Moreover, FIG. 5(c) is a diagram illustrating a display state in a dual view mode which is different from the display state in the dual view mode illustrated in FIG. 5(a).

FIG. 6 illustrates yet another example of display on the multi-image display apparatus according to Embodiment 1.

FIG. 7 is a plan view of a multi-image display apparatus and illustrates one modified example of the multi-image display apparatus according to Embodiment 1.

FIG. 8(a) and 8(b) each illustrates one example of display on a multi-image display apparatus according to Embodiment 2.

FIG. 9 is a plan view of a multi-image display apparatus and illustrates one modified example of the multi-image display apparatus according to Embodiment 2.

FIG. 10 is a diagram illustrating an effect of viewing angles given by a parallax barrier in a case where three dimensional display is carried out or the like.

FIG. 11 is a diagram illustrating observing regions of a three dimensional display screen.

FIGS. 12(a) and 12(b) are diagrams illustrating a relationship between a display screen and an observer(s). FIG. 12(a) is a diagram illustrating a case where three dimensional display is carried out. FIG. 12(b) is a diagram illustrating a case where dual image display is carried out.

### DETAILED DESCRIPTION OF PREFERRED EMBODIMENTS

### Example of Arrangement of Multi-Image Display Apparatus

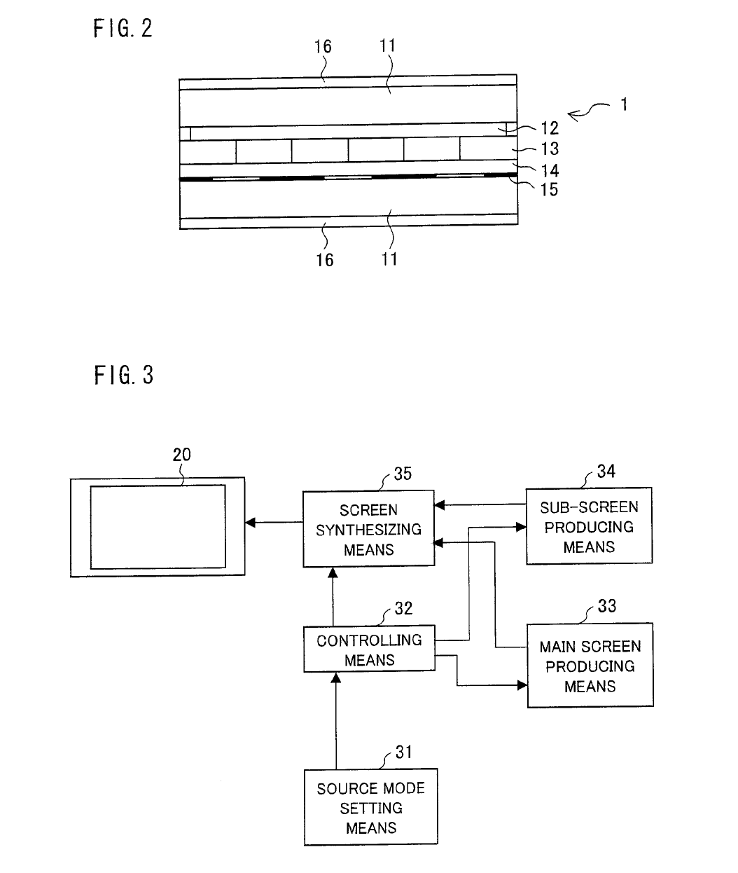

One embodiment according to the present invention is explained as follows, with reference to drawings. First, with reference to FIG. 2, explained below is an example of an arrangement of a display panel in a multi-image display apparatus of the present Embodiment. The following explanation explains as an example a system in which a parallax barrier is used in combination with a liquid crystal display panel. However, a kind of a panel in the present invention is not limited to a liquid crystal panel. In the present invention, a display system for carrying out multi-image display is also not specifically limited to a parallax barrier system.

As illustrated in FIG. 2, a liquid crystal display panel 1 is arranged so that a liquid crystal layer 12, a color filter 13, a thick resin layer 14, and a parallax barrier layer 15 are formed between two transparent substrates 11 on which a transparent electrode layer (not shown) and an alignment film (not shown) are formed. On each of the two transparent substrates 11, a polarizer 16 is further provided.

In other words, in the liquid crystal panel 1, the parallax barrier layer 15 is formed between the two transparent substrates 11, namely, in a cell. If a parallax layer 15 is formed in contact with a color filter 13, then it does not function as a parallax barrier. As such, the thick resin layer 14 is provided between the parallax barrier layer 15 and the color filter 13. Thickness of the thick resin layer 14 allows adjustment of an appropriate distance between the parallax barrier 15 and the color filter 13.

The above-mentioned arrangement makes it possible to produce a liquid crystal panel 1 in which a color filter 13 and a parallax barrier layer 15 are set to maintain their close distance (approximately 50 82 m to 100 μm) suitable for a multi-image display. In a display panel carrying out a multi-image display, it is necessary to dispose a parallax barrier layer 15 and a pixel layer (the color filter 13 in this example) closer to each other compared with a panel carrying out a three dimensional display. Accordingly, it is preferable to have an arrangement in which a parallax barrier layer 15 is provided in a cell.

In the liquid crystal panel 1, the thick resin layer 14 adjusts the distance between the color filter 13 and the parallax barrier 15, because the color filter 13 has a predetermined pixel pitch and is disposed closest to the parallax barrier layer 15. In a case where the liquid crystal panel 1 does not include the color filter 13 or in a case where the liquid crystal layer 12 is disposed closer to the parallax barrier layer 15 than the color filter 13 is, the thick resin layer 14 adjusts a distance between the liquid crystal layer 12 and the parallax barrier layer 15.

The following procedure illustrates a production process of one of the two substrates having the liquid crystal layer 12 therebetween, on which substrate the thick resin layer 14 and the parallax barrier layer 15 are provided.

First, a parallax barrier layer 15 is formed on one side of a transparent substrate 11 such as a glass substrate or the like. The parallax barrier layer 15 is obtained by (i) forming a film made of a light shielding material (resin, metal, or the like) on a surface of the transparent substrate 11 so that the film has a predetermined thickness and (ii) patterning the film.

On thus obtained parallax barrier layer 15, the thick resin layer 14 is further formed with a transparent resin such as acrylic resin. The thick resin layer 14 is formed to have a predetermined thickness so that an appropriate distance is maintained between the parallax barrier layer 15 and the color filter 13. On the thick resin layer 14, the color filter 13 is formed. On this color filter 13, a transparent electrode layer and an alignment layer are further formed.

A relationship between a parallax barrier and a display pattern, and the like, are realized with the use of a technique disclosed in Japanese Unexamined Patent Publication No. 206089/2004 (Tokukai 2004-206089) (published on Jul. 22, 2004) (Patent Document 9).

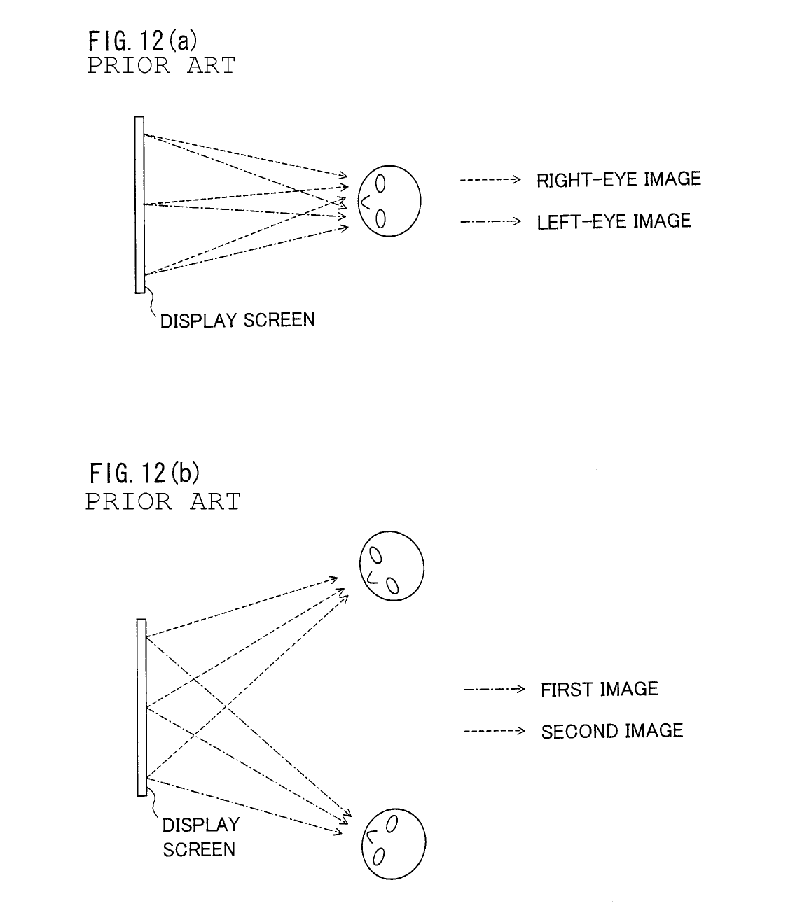

The liquid display panel 1 can carry out a multi-image display, which is not limited to a dual image display as shown in FIG. 12(b). However, the explanation below is given on the assumption that the liquid crystal display panel 1 carries out a dual image display. Moreover, as to a relationship between a first image and a second image, the liquid crystal display panel 1 can display not only the first image and the second image which are different to each other, but also the first image and the second image which are identical.

A multi-image display apparatus according to the present invention is characterized by being capable of providing each observer with information on an image that another observer is seeing. A method realizing this is explained in the following Embodiments 1 and 2.

### Embodiment 1

A display mode in which a first image and a second image which are different to each other are displayed is referred to as a multiple screen display mode (hereinafter referred to as a dual view mode), and a display mode in which a first image and a second image which are identical are displayed is referred to as an identical screen display mode (hereinafter referred to as a single view mode). A multi-image display apparatus of Embodiment 1 makes it possible that each observer recognizes whether a present display mode is a dual view mode or a single view mode.

The single view mode here indicates a mode in which an identical image is displayed on separate two screens of the multi-image display apparatus arranged as illustrated in FIG. 2. However, an arrangement of the multi-image display apparatus is not limited to the arrangement illustrated in FIG. 2. A multi-image display maybe arranged so that a regular liquid crystal display panel which does not include a parallax barrier is combined with parallax barrier means that can electrically switch between validity and invalidity of a parallax barrier effect. According to this arrangement, when an effect of the parallax barrier means is switched to be valid, a dual view mode display is possible, whereas it is possible to carry out a single screen display on the full screen of a display section (single screen display mode),when the effect of the parallax barrier means is switched to be invalid. Such a single screen display mode is also included in the single view mode (an identical screen display mode).

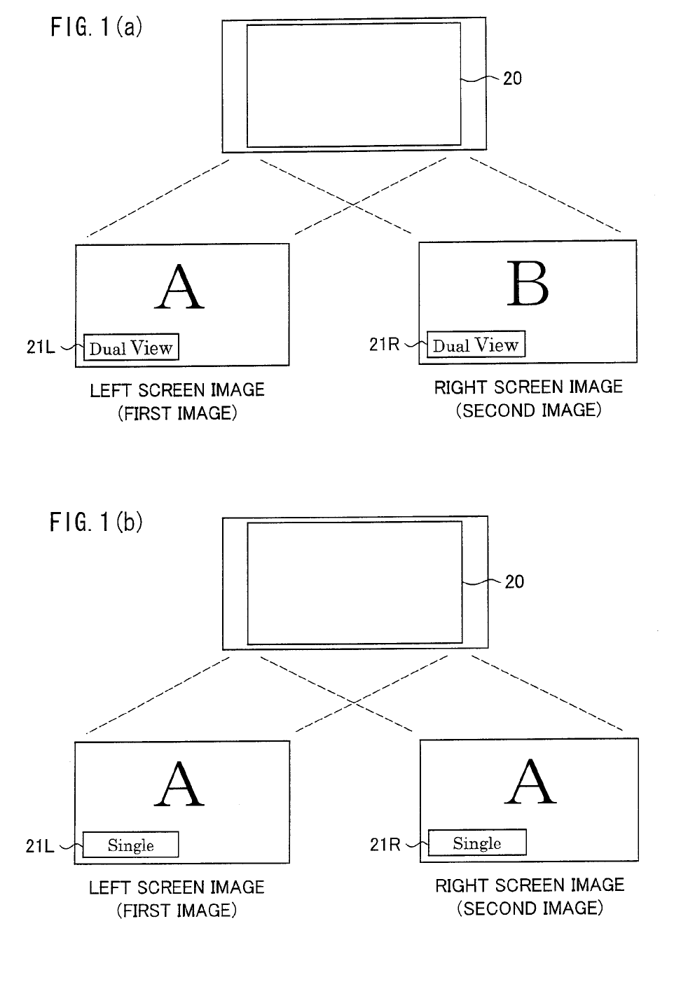

In Embodiment 1, as illustrated in FIGS. 1(a) and 1(b), a sub-screen 21L and a sub-screen 21R, which show information on a present display mode, are displayed in a screen image (left screen image) viewed from the left side of the display section 20 and a screen image (right screen image) viewed from the right side of the display section 20, respectively. This makes it possible for an observer to recognize whether the present display mode is a dual view mode or a single view mode. In FIG. 1(a), an screen image A is displayed as the left screen image and a screen image B is displayed as the right screen image. In this case, an icon indicating a dual view mode is displayed on each of the sub-screens 21L and 21R. In FIG. 1(b), a screen image A is displayed as each of the left screen image and the right screen image. In this case, an icon indicating a single view mode is displayed on the sub-screens 21L and 21R.

Here, explained with reference to FIG. 3 is an example arrangement of the multi-image display apparatus that can realize the sub-screen display as mentioned above. The multi-image display apparatus, as illustrated in FIG. 3, includes a display section 20, source mode setting means 31, controlling means 32, main screen producing means 33, sub-screen producing means 34, and screen synthesizing means 35.

The source mode setting means 31 is means for setting a source mode in accordance with a user input, which source mode identifies a source and causes an image from the source to be displayed as each of the left screen image and the right screen image. In other words, a setup of the source mode decides an image displayed as each of the left screen image and the right screen image. For example, when a multi-image display apparatus of the present invention is applied to a car navigation apparatus, a screen image (generally, right screen image) viewed from a driver seat is supposed to be for a navigation screen and a screen image (generally, left screen image) viewed from a front passenger seat is supposed to be for a television screen. In such a case, the source mode setting means 31 sets the source modes so that the navigation screen and the television screen are respectively displayed as the left screen image and the right screen image. When a multi-image display apparatus of the present invention is applied to a television, images of different channels are assumed to be displayed as the right screen image and left screen image, respectively. In such a case, the source mode setting means 31 carries out channel setting for each of the left screen image and the right screen image.

The controlling means 32 is means for controlling all of the source mode setting means 31, the main screen producing means 33, the sub-screen producing means 34, and the screen synthesizing means 35.

The main screen producing means 33 produces main screen images, respectively displayed as the right screen image and the left screen image, in accordance with source modes set by the source mode setting means 31. The sub-screen producing means 34 is means for producing the sub-screen. The sub-screen producing means 34 produces a sub-screen in accordance with information on the display mode received from the controlling means 32. The controlling means 32 recognizes the source modes set by the source mode setting means 31 respectively for the left screen image and the right screen image, before informing the sub-screen producing means 34 of the information on the display modes. When the source modes are identical, the controlling means 32 determines that the display modes are a single view mode. On the other hand, when the source modes are different from each other, the controlling means 32 determines that the display modes are a dual view mode.

The screen synthesizing means 35 is means for synthesizing a main image and a sub-image so as to produce a display screen as illustrated in FIGS. 1(a) and 1(b). The display section 20 is means for displaying the display screen. The display section 20 includes the display panel 1 and a driving circuit that drives the display panel 1.

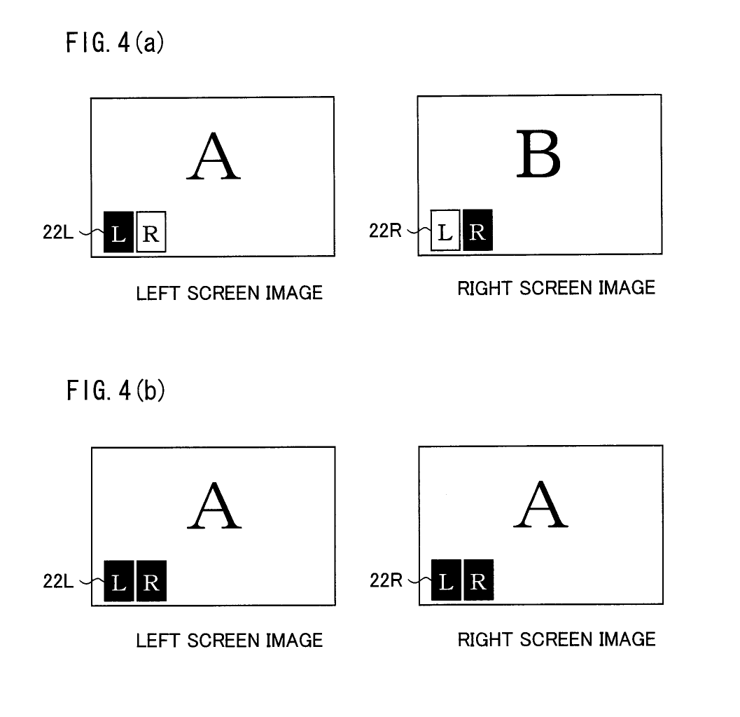

Note that an example of each display on the sub-screens 21L and 21R as illustrated in FIGS. 1(a) and 1(b) is merely one example. A method of displaying the sub-screen may have various patterns other than this. For example, as illustrated in FIGS. 4(a) and 4(b), the sub-screens 21L and 21R composed of L and R character icons may be displayed respectively in the left screen image and the right screen image on the display section 20.

FIG. 4(a) illustrates a case where different screen images are displayed as the right screen image and the left screen image. In such a case, only the L character icon lights up (In FIG. 4(a), white letter on a black background illustrates a state in which the icon is lighting up.) on the sub-screen 22L in the left screen image. The lighted L character icon notifies that the left screen image is an image displayed only on the left screen at the time. Similarly, an only R character icon lights up on the sub-screen 22R in the right screen image. This notifies that the right screen image is displayed only on the right screen at the time.

FIG. 4(b) illustrates a case where an identical screen image is displayed as the right screen image and the left screen image, respectively. In this case, both of the L character icon and the R character icon lights up on the sub-screen 22L in the left screen image and the sub-screen 22R in the right screen image. This notifies that the same screen image is displayed on both of the right screen and the left screen at the time.

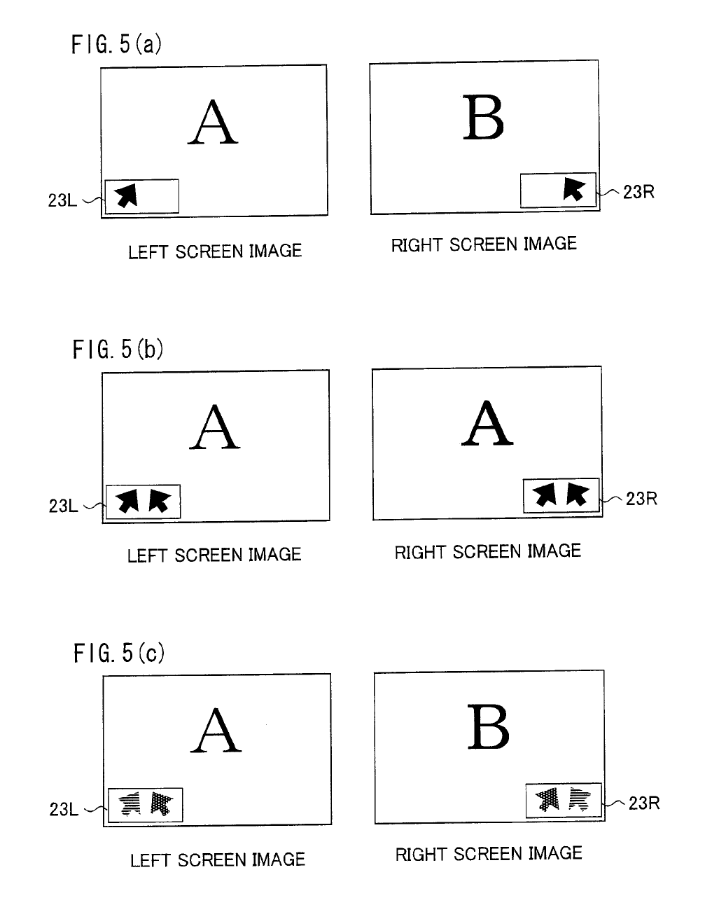

As in FIGS. 5(a) and (b) illustrating yet another example, sub-screens 23L and 23R composed of arrow icons may be displayed respectively in the left screen image and the right screen image.

FIG. 5(b) illustrates a case where an identical screen image is displayed as the left screen image and the right screen image. In this case, in each of the sub-screen 23L in the left screen image and the sub-screen 23R in the right screen image, both of the arrow icon pointing right (indicating the left screen image) and the arrow icon pointing left (indicating the right screen image) light up together. This notifies that the right screen image and the left screen image are an identical screen image at the time.

FIG. 5(a) illustrates a case where different screen images are displayed respectively as the left screen image and the right screen image. In such a case, only an arrow icon pointing right lights up on the sub-screen 23L in the left screen image. On the other hand, only an arrow icon pointing left lights up on the sub-screen 23R in the right screen image. These sub-screen displays can notify that the screen image is displayed only as the right screen image or as the left screen image at the time.

Alternatively, as illustrated in FIG. 5(c), the arrow icon pointing right on the sub-screen 23L in the left screen image and the arrow icon pointing left on the sub-screen 23R in the right screen image may light up in different colors, thereby notifying that different screen images are displayed respectively as the left screen image and the right screen image at the time.

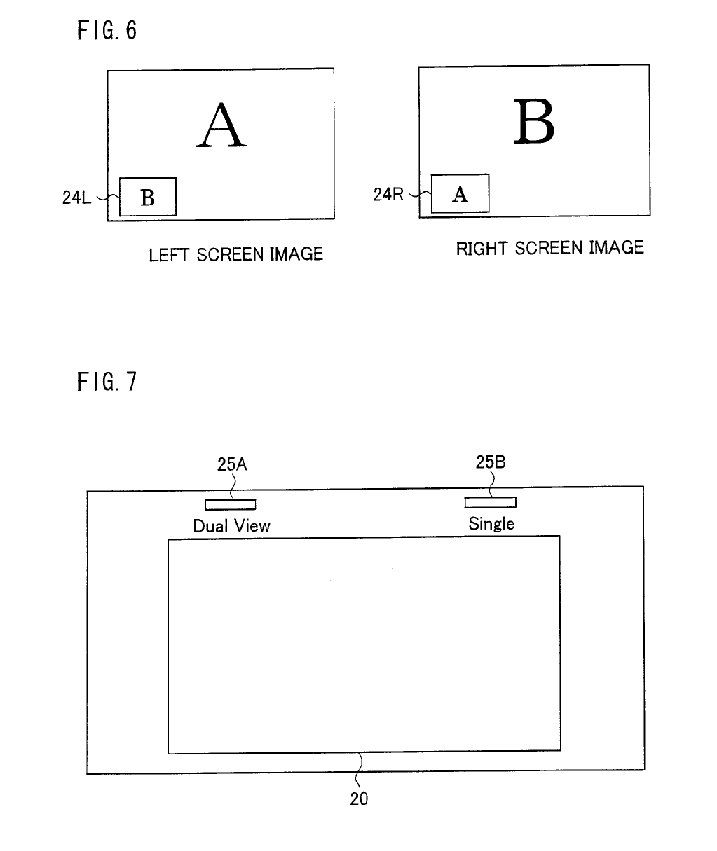

In Embodiment 1 of the present invention, instead of using the icon display on the sub-screen as illustrated in FIG. 1, 4, or 5. As illustrated in FIG. 6, a reduced image of the other screen image may be displayed on the sub-screen. Specifically, in a case where a screen image A is displayed as the left screen image and a screen image B is displayed as the right screen image, a reduced image of the screen image B is displayed on the sub-screen 24L, and a reduced screen display of the screen image A is displayed on the sub-screen 24R.

However, in a case where the present invention is applied to, for example, a car navigation apparatus, the screen size of a display section 20 is small and it is difficult to recognize the content of a sub-screen on which a reduced image of the other screen image is displayed. As such, in such a case, it is preferable to use an icon display by which the information is easily conveyed even on a small screen. Moreover, the icon display is effective in reducing load required for carrying out image processing.

The multi-image display apparatus of the present invention adopts a method of informing each observer whether the present display mode is a dual view mode or a single view mode, but such a method is not limited specifically to a method of displaying a sub-screen on a display screen. As another method, for example, as illustrated in FIG. 7, the display mode may be informed by providing outside the display section 20 with LEDs (Light Emitting Diodes) 25A and 25B as display mode informing means so that the LEDs light up. In the example illustrated in FIG. 7, the lighted LED 25A can inform that the display mode is a dual view mode, whereas the lighted LED 25B can inform that the display mode is a single view mode. Instead of lighting of the LEDs, it is also possible to inform whether the display is in a dual view mode or a single view mode, by using LEDs illuminating in different colors. Here, it is assumed that it is possible to view and recognize from the left and right sides whether or not the LEDs are lighting up.

Alternatively, an audio assist may be used so as to inform the observer of a current display mode, when a change is made to the setting of the source mode for either the left screen image or the right screen image.

In the explanation of Embodiment 1, a sub-screen display is carried out in each of a dual view mode and a single view mode. However, it is also possible to display a sub-screen display only in either one of the display modes. For example, the sub-screen display may be carried out during a dual view mode but not during a single view mode. In such a case, absence of the sub-screen display can inform the observer that the display mode at the time is a single view mode. On the contrary, it may be possible that the sub-screen display is carried out during a single view mode but not during a dual view mode.

In a case where LEDs are used as display mode informing means, instead of providing the two LEDs as shown in FIG.7, it is possible to recognize whether the current display mode is a dual view mode or a single view mode, by (i) lightening up/extinguishing an LED, (ii) using LEDs illuminating in different colors, or (iii) changing brightness of LED light.

### Embodiment 2

In an arrangement of the multi-image display apparatus in Embodiment 1 explained above, each observer is informed whether the present display mode is a dual view mode or a single view mode. However, it is possible that a multi-image display apparatus has three or more choices of source modes. For example, a car navigation apparatus may have a setting screen of an air conditioner, an audio system, or the like as a source mode other than the source modes corresponding to a navigation screen and a television screen.

In such a case, each observer cannot know a source mode that the other observer sees only by notification of the information which informs the observer whether the display mode is a dual view mode or a single view mode. Accordingly, this may cause a problem such that, for example, a driver makes air conditioner settings with the use of a dial while, with the use of a touch panel, a passenger seating in a front passenger seat makes air conditioner settings in a manner that is different from a manner that the driver does. This may impair usability of the apparatus.

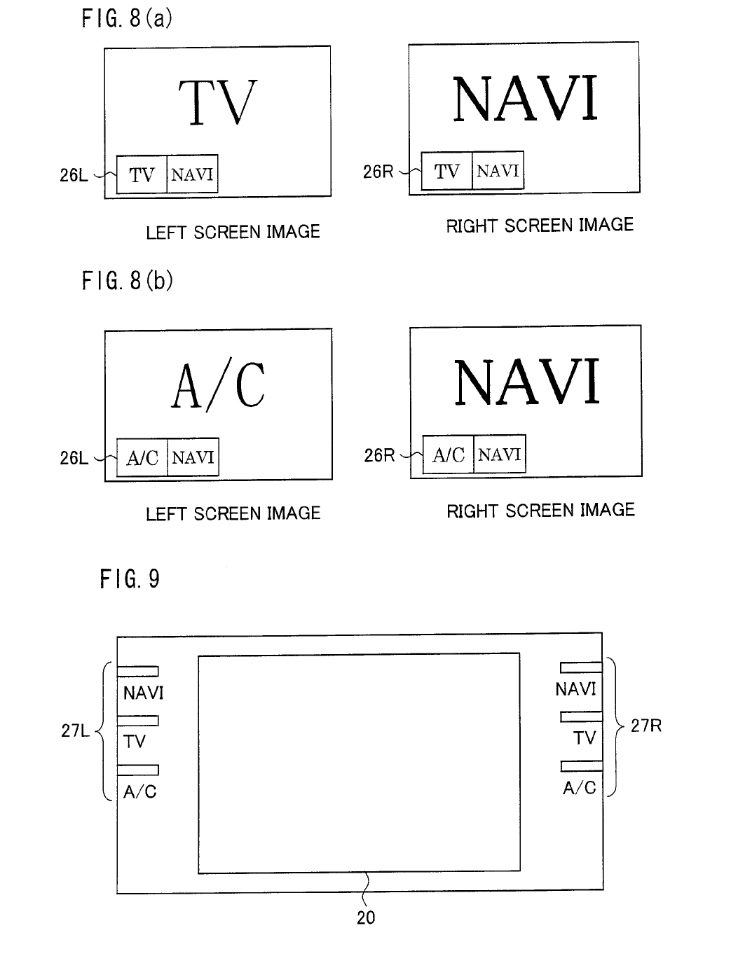

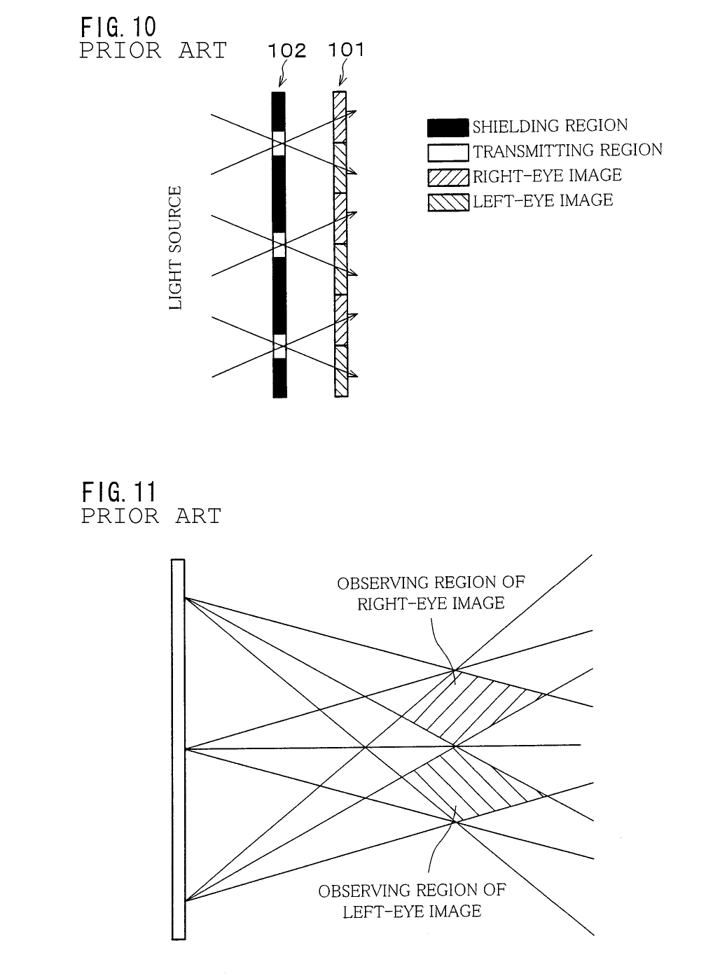

In order to avoid the problem mentioned above, in an arrangement according to Embodiment 2, as illustrated in FIGS. 8(a) and 8(b), sub-screens 26L and 26R showing information on respective source modes of displays presently shown are displayed in a left screen image and a right screen image, respectively. The sub-screens 26L and 26R display icons corresponding to the respective source modes of the displays in the left screen image and the right screen image.

FIG. 8(a) illustrates a display state when the left screen image is a television screen image and the right screen image is a navigation screen image. FIG. 8(b) illustrates a display state when the left screen image is an image of an air conditioner setting screen and the right screen image is a navigation screen image.

As in Embodiment 1, in Embodiment 2, a method of informing each observer of a source mode of present display is not limited to the method of displaying the sub-screen in the display screen. One example of a method other than the method using the sub-screen is, as illustrated in FIG. 9, a method of indicating a display source mode by lightening up LEDs 27L and 27R, which are provided outside the display section, as display source mode informing means. In the example illustrated in FIG. 9, each of the LEDs 27L and 27R is composed of as many LEDs as source modes that can be displayed. The source mode of the present display can be indicated by the LED lit up.

In Embodiments 1 and 2, the sub-display is not necessarily displayed all the time. For example, the sub-screen display may be arranged such that, when a change is made to the setting of the source mode for either in the left screen image or the right screen image, the sub-screen is displayed for a while and disappears a predetermined time after the change.

Moreover, the sub-screen display in the left screen image is not necessarily the same as the sub-screen display in the right screen image. For example, in a case where the multi-image display apparatus of the present invention is applied to a car navigation apparatus, the sub-screen display may be arranged so that the sub-screen is displayed only in the right screen image viewed from the driver seat but not in the left screen image viewed from the front passenger seat. Inversely, it is also possible to display the sub-screen display only in the left screen image but not in the right screen image.

Additionally, it is preferable that a display pattern (e.g. whether or not the sub-screen is displayed all the time, whether or not it is necessary to display the sub-screen in each of the left screen image and the right screen image, or the like) of the above-mentioned sub-display screen is user-configurable.

As mentioned above, according to the present invention, a multi-image display apparatus capable of displaying different images when viewed from a plurality of view points includes display information providing means which is capable of providing display information concerning an image viewed from another view point.

According to the above-mentioned arrangement, in carrying out a multi-image display on the multi-image display apparatus, the display information providing means can provide the information on an image that another observer sees to each observer. This allows to avoid an occurrence of a problem in that each observer cannot recognize an image that another observer sees and thus communication between the observers becomes difficult.

In the multi-image display apparatus according to the present invention, the display information providing means may be arranged as a sub-screen incorporated in an image that is visible from each of view points, or display information informing means provided outside a display section.

In a case where the display information providing means is arranged as the sub-display incorporated in an image that is visible from each of view points, it is preferable that the sub-screen displays an icon corresponding to the display information concerning an image viewed from another view point.

According to the arrangement mentioned above, in a case where the present invention is applied to a multi-image display apparatus having a small display screen area, for example, a car navigation apparatus, the information can be easily recognized even in a small sized screen. Moreover, the icon display reduces load produced by the image processing.

The above-mentioned sub-screen may be arranged so as to show whether a display mode is an identical screen display mode or a multi-screen display mode. Alternatively, the above-mentioned sub-screen may also be arranged to show a source mode selected for display on each screen.

In a case where the display information providing means is arranged as the display information informing means provided outside the display section, the display information informing means may be arranged so as to indicate whether a display mode is an identical screen display mode or a multi-screen display mode by lighting an LED. Alternatively, the display information informing means may also be arranged so as to indicate a source mode selected for display on each screen by lightening an LED.

The present invention is applicable to a multi-image display apparatus capable of displaying different images when viewed from a plurality of view points.

1. A multi-image display apparatus capable of displaying different images when viewed from a plurality of view points, the multi-image display apparatus comprising
display information providing means which is capable of providing display information concerning an image viewed from another view point.

2. The multi-image display apparatus as set forth in claim 1, wherein
the display information providing means is a sub-screen incorporated in an image that is visible from each of the view points.

3. The multi-image display apparatus as set forth in claim 1, wherein
the display information providing means is display information informing means provided outside a display section.

4. The multi-image display apparatus as set forth in claim 2, wherein
the sub-screen displays an icon corresponding to the display information concerning an image viewed from another view point.

5. The multi-image display apparatus as set forth in claim 4, wherein
the sub-screen shows whether a display mode is an identical screen display mode or a multi-screen display mode.

6. The multi-image display apparatus as set forth in claim 4, wherein
the sub-screen shows a source mode selected for display on each screen.

7. The multi-image display apparatus as set forth in claim 3, wherein
the display information informing means indicates whether a display mode is an identical screen display mode or a multi-screen display mode by lighting an LED.

8. The multi-image display apparatus as set forth in claim 3, wherein
the display information informing means indicates a source mode selected for display on each screen by lightning an LED.
